(19) United States
(12) Patent Application Publication
(10) Pub. No.: US 2020/0413094 A1
(43) Pub. Date: Dec. 31, 2020

(54) METHOD AND APPARATUS FOR ENCODING/DECODING IMAGE AND RECORDING MEDIUM FOR STORING BITSTREAM

(71) Applicant: Electronics and Telecommunications Research Institute, Daejeon (KR)

(72) Inventors: Gwang Soon LEE, Daejeon (KR); Hong Chang SHIN, Daejeon (KR); Kug Jin YUN, Daejeon (KR); Jun Young JEONG, Seoul (KR)

(73) Assignee: Electronics and Telecommunications Research Institute, Daejeon (KR)

(21) Appl. No.: 16/900,635

(22) Filed: Jun. 12, 2020

(30) Foreign Application Priority Data
Jun. 14, 2019 (KR) 10-2019-0071108
Jan. 13, 2020 (KR) 10-2020-0004462
Jun. 12, 2020 (KR) 10-2020-0071443

(51) Int. Cl. H04N 19/597; H04N 19/66; H04N 19/122; H04N 19/176

(52) U.S. Cl. CPC H04N 19/597; H04N 19/176; H04N 19/122; H04N 19/66

(57) ABSTRACT

Disclosed herein are an image encoding/decoding method and apparatus and a recording medium storing a bitstream. A multi-view image decoding method for a multi-view image comprising a basic-view image and at least one additional view image, the multi-view image decoding method comprising: obtaining a bitstream comprising basic-view image encoding information on the basic-view image and residual additional view image encoding information on a plurality of residual additional view images; decoding the basic-view image and the plurality of residual additional view images based on the bitstream; and reconstructing the at least one additional view image from the plurality of residual additional view images based on the basic-view image encoding information, the residual additional view image encoding information and the basic-view image, wherein the residual additional view image encoding information comprises packing information of a patch, and wherein the packing information comprises information on an importance of the image region belonging to the additional view image.

### CROSS REFERENCE TO RELATED APPLICATION

The present application claims priority to KR10-2019-0071108, filed Jun. 14, 2019, KR10-2020-0004462, filed Jan. 13, 2020 and KR10-2020-0071443, filed Jun. 12, 2020, the entire contents of which are incorporated herein for all purposes by this reference.

### BACKGROUND OF THE INVENTION

### Field of the Invention

The present invention relates to an image encoding/decoding method and apparatus and a recording medium storing a bitstream. Particularly, the present invention relates to an image encoding/decoding method and apparatus and a recording medium storing a bitstream for providing omnidirectional video for the corresponding motion parallax to a viewer' s left-and-right/up-and-down rotation and left-and-right/up-and-down translation.

### Description of the Related Art

Virtual reality services generate full 360-degree videos in realistic or computer graphics (CG) formats, play such videos on a personal VR unit (for example, head mounted display (HMD), smartphone, etc.), and evolve to maximize senses of immersion and realism.

Researches to data have shown that 6 degrees of freedom (DoF) need to be reproduced in order to play a natural and highly immersive full 360-degree video through an HMD. In other words, an image is to be played through an HMD so that it can be viewed by a viewer moving in six directions including (1) left-and-right translation, (2) up-and-down rotation, (3) up-and-down translation, and (4) left-and-right rotation. As of now, an omnidirectional video for playing a realistic image obtained by a camera has 3 DoF. Since the video senses movements by mainly focusing on the up-and-down rotation and the left-and-right rotation, it does not provide and play any image gazed by a viewer in the left-and-right translation and the up-and-down translation.

The MPEG (Moving Picture Experts Group) standardization group defines immersive media as media for maximizing the sense of immersion and is working on standards required for efficient encoding and transmission of immersive videos in stages. In particular, as the next stage of 3 DoF, which is the most basic immersive video, 3 DoF+ is an immersive video for reproducing motion parallax in an environment where a viewer is seated. Standardization will proceed in stages until further stages like Omnidirectional 6 DoF for providing the corresponding motion parallax to a viewer' s walking a few steps and 6 DoF for providing complete motion parallax along with a viewer' s free movement. When the immersive video utilizes a multi-view omnidirectional video (for example, equi-rectangular projection (ERP) format, cubemap format, etc.), the windowed-6 DoF may be similar to the conventional multi-view video technology with horizontal/vertical parallax. Here, the windowed-6 DoF is a technique of providing motion parallax through a single-view window by using a multi-view monoscopic video (for example, HD, UHD, etc.).

### SUMMARY OF THE INVENTION

The present disclosure is directed to provide an image encoding/decoding method and apparatus for supporting motion parallax and a recoding medium for storing a bitstream.

The present disclosure is also directed to provide an immersive video formatting method and apparatus for playing a natural omnidirectional video through a VR terminal.

The technical objects of the present disclosure not limited to the above-mentioned technical objects, and other technical objects that are not mentioned will be clearly understood by those skilled in the art from the following description.

According to the present invention, a multi-view image encoding method may be provided. The multi-view image encoding method may include: generating at least one patch by performing pruning for the at least one additional view image on the basis of the basic-view image; packing the at least one patch; generating a plurality of residual additional view images on the basis of the at least one packed patch; and outputting a bitstream comprising residual additional view image encoding information on the plurality of residual additional view images, wherein the packing of the at least one patch is performed based on an importance of an image region belonging to the additional view image.

the packing of the at least one patch comprises adjusting a size of the patch according to the importance of the image region belonging to the additional view image.

the packing of the at least one patch comprises rotating the patch according to the importance of the image region belonging to the additional view image.

the importance of the image region belonging to the additional view image is determined on the basis of at least one of a depth value of the image region, a position of a camera used to obtain the image region, whether or not the image region is a region of interest, and a complexity of the region.

the packing of the at least one patch comprises setting a guard band in a boundary portion of the at least one patch.

the setting of the guard band comprises setting the guard band according to the importance of the image region belonging to the additional view image.

the setting of the guard band comprises copying a sample value adjacent to the boundary region of the at least one patch.

the setting of the guard band sets the guard band by interpolating a plurality of samples comprised in the boundary region of the at least one patch.

the packing of the at least one patch comprises: determining a similarity of a plurality of image regions belonging to the additional view image; and packing the at least one patch into a single patch on the basis of a result of the similarity determination.

the bitstream further comprises basic-view image encoding information on the basic-view image.

In addition, according to the present invention, a multi-view image decoding method may be provided. The multi-view image decoding method may include: obtaining a bitstream comprising basic-view image encoding information on the basic-view image and residual additional view image encoding information on a plurality of residual additional view images; decoding the basic-view image and the plurality of residual additional view images based on the bitstream; and

reconstructing the at least one additional view image from the plurality of residual additional view images based on the basic-view image encoding information, the residual additional view image encoding information and the basic-view image, wherein the residual additional view image encoding information comprises packing information of a patch, and wherein the packing information comprises information on an importance of the image region belonging to the additional view image.

a size of the patch is determined based on the importance of the image region belonging to the additional view image.

the importance of the image region belonging to the additional view image is determined on the basis of at least one of a depth value of the image region, a position of a camera used to obtain the image region, whether or not the image region is a region of interest, and a complexity of the region.

the packing information comprises information on a guard band of the patch.

the guard band is determined based on the importance of the image region belonging to the additional view image.

the packing information comprises information on a similarity of a plurality of image regions belonging to the additional view image.

In addition, a recording medium according to the present invention may store a bitstream generated by a multi-view image encoding method according to the present invention.

The present disclosure may provide an image encoding/decoding method and apparatus for supporting motion parallax and a recording medium for storing a bitstream.

In addition, the present disclosure may provide a method and apparatus for providing a perfect and natural stereoscopic image to a VR device by playing images corresponding not only to a viewer' s up-and-down and left-and-right rotations but also to the viewer' s up-and-down and left-and-right translations.

In addition, according to the present disclosure, as the volume of data transmitted is reduced by scaling and rotation in each patch, the packing efficiency of a patch may be enhanced.

Effects obtained in the present invention are not limited to the above-mentioned effects, and other effects not mentioned above may be clearly understood by those skilled in the art from the following description.

### BRIEF DESCRIPTION OF THE DRAWINGS

FIG. 1 is a view for explaining the concept of immersive video according to an embodiment of the present invention.

FIG. 2 is a view for explaining an encoder structure of immersive video according to an embodiment of the present invention.

FIG. 3 is a view for explaining a patch packing process according to an embodiment of the present invention.

FIG. 4 is a view for explaining a method of adjusting a patch size by using the importance of an image region to be extracted into a patch, according to an embodiment of the present invention.

FIG. 5 is a view for explaining a method of improving an encoding efficiency by adjusting the width of a guard band, according to an embodiment of the present invention.

FIG. 6 is a view for explaining a method of packing similar multiple patch regions into a single patch, according to an embodiment of the present invention.

FIG. 7 is a view for explaining a patch packing method for each atlas according to an embodiment of the present invention.

FIG. 8 is a view for explaining a method of performing video encoding differently for each atlas, according to an embodiment of the present invention.

FIG. 9 is a view for explaining a method of encoding a multi-view image according to an embodiment of the present invention.

FIG. 10 is a view for explaining a method of decoding a multi-view image according to an embodiment of the present invention.

### DETAILED DESCRIPTION OF THE INVENTION

A variety of modifications may be made to the present invention and there are various embodiments of the present invention, examples of which will now be provided with reference to drawings and described in detail. However, the present invention is not limited thereto, although the exemplary embodiments can be construed as including all modifications, equivalents, or substitutes in a technical concept and a technical scope of the present invention. The similar reference numerals refer to the same or similar functions in various aspects. In the drawings, the shapes and dimensions of elements may be exaggerated for clarity. In the following detailed description of the present invention, references are made to the accompanying drawings that show, by way of illustration, specific embodiments in which the invention may be practiced. These embodiments are described in sufficient detail to enable those skilled in the art to implement the present disclosure. It should be understood that various embodiments of the present disclosure, although different, are not necessarily mutually exclusive. For example, specific features, structures, and characteristics described herein, in connection with one embodiment, may be implemented within other embodiments without departing from the spirit and scope of the present disclosure. In addition, it should be understood that the location or arrangement of individual elements within each disclosed embodiment may be modified without departing from the spirit and scope of the embodiment. The following detailed description is, therefore, not to be taken in a limiting sense, and the scope of the exemplary embodiments is defined only by the appended claims, appropriately interpreted, along with the full range of equivalents to what the claims claim.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without departing from the scope of the present invention, and the ‘second’ component may also be similarly named the ‘first’ component. The term ‘and/or’ includes a combination of a plurality of items or any one of a plurality of terms.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. In contrast, it should be understood that when an element is referred to as being “directly coupled” or “directly connected” to another element, there are no intervening elements present.

Furthermore, constitutional parts shown in the embodiments of the present invention are independently shown so as to represent characteristic functions different from each other. Thus, it does not mean that each constitutional part is constituted in a constitutional unit of separated hardware or software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. In other words, when a specific element is referred to as being “included”, elements other than the corresponding element are not excluded, but additional elements may be included in embodiments of the present invention or the scope of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

Hereinafter, embodiments of the present invention will be described in detail with reference to the accompanying drawings. In describing exemplary embodiments of the present invention, well-known functions or constructions will not be described in detail since they may unnecessarily obscure the understanding of the present invention. The same constituent elements in the drawings are denoted by the same reference numerals, and a repeated description of the same elements will be omitted.

In the present specification, an immersive video is a video enabling a user to experience a sense of immersion and may mean an image of 3 DoF, 3 DoF+, or 6 DoF. Here, immersion may be defined as a phenomenon that blurs the line between real and virtual worlds.

In the present specification, a video format may mean a standard for enabling a video to be used in a particular program. In addition, formatting may mean modifying a video type to suit the standard.

In the present specification, the term “video” may be used in the same meaning as “image” and “moving picture”.

Hereinafter, embodiments of the present invention will be described with reference to the accompanying drawings.

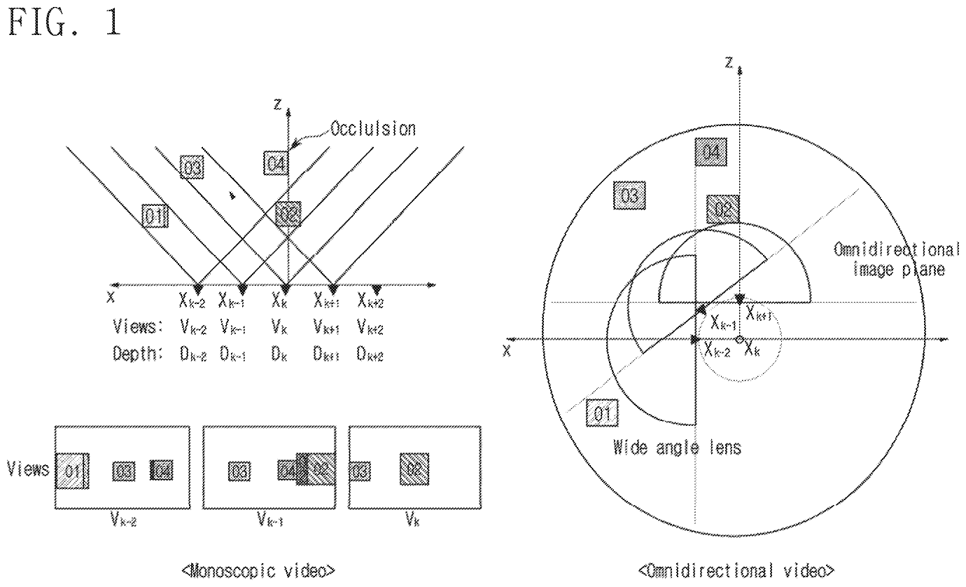

FIG. 1 is a view for explaining the concept of immersive video according to an embodiment of the present invention.

Referring to FIG. 1, the object 1(01) to the object 4(04) may mean each video region within an arbitrary scene. Vₖ, Xₖ and Dₖ may mean an image obtained at a camera center position (basic-view image or reference view image), a view position (camera position), and depth information in the camera center position, respectively. In order to support 6 DoF along with a viewer' s movement, an immersive video may be generated by using a base video (Vk) seen at a center position (or central position, reference position) (Xk), a multi position video (Vk−2, Vk−1, . . . ) at a multi-view position (Xk−2, Xk−1, . . . ), which is seen by a viewer in motion, and relevant spatial information (for example, depth information and camera information). The immersive video may be transmitted to a terminal through video coding and packet multiplexing. Here, a base video and/or multi position video may be a monoscopic video or an omni-directional video.

Accordingly, since an immersive media system is required to obtain, generate, transmit and represent a large immersive video consisting of multi views, a large volume of data should be effectively stored and compressed. When an immersive video system for 3 DoF+ or 6 DoF is configured, the maintenance of compatibility with the conventional immersive video (3 DoF) is to be considered.

Meanwhile, an immersive video formatting apparatus may obtain a basic-view image, a multi-view image, etc., and a receiver (not illustrated herein) may perform the operations.

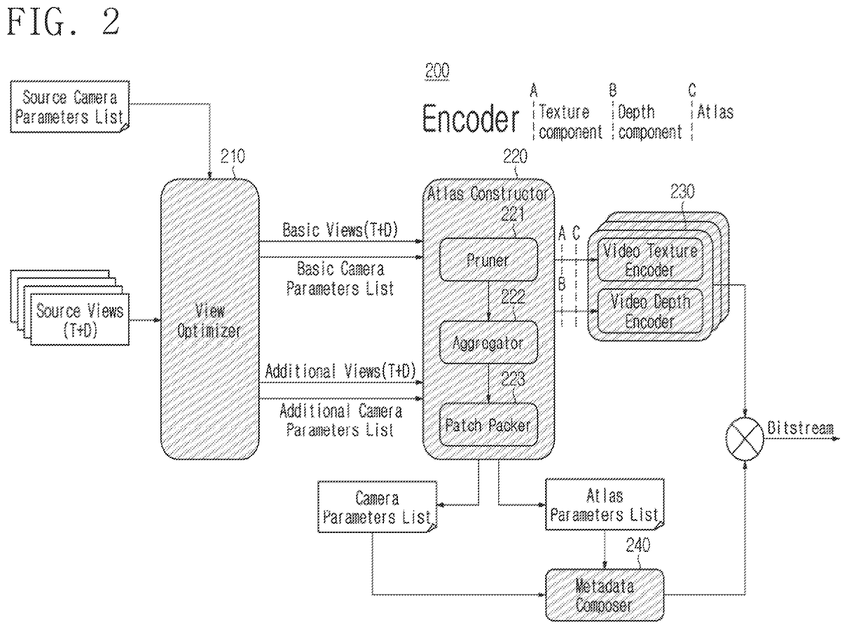

FIG. 2 is a view for explaining an encoder structure of immersive video according to an embodiment of the present invention.

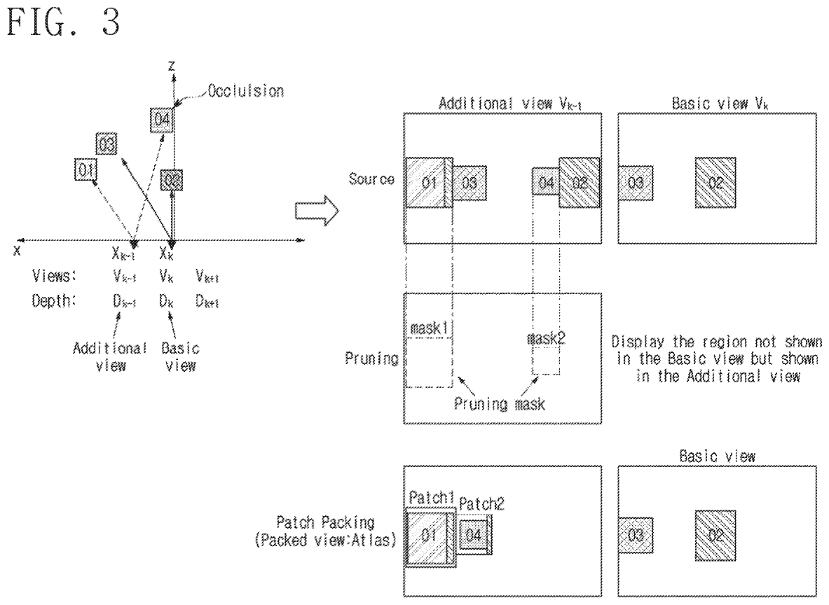

FIG. 3 is a view for explaining a patch packing process according to an embodiment of the present invention.

Referring to FIG. 2, an encoder 200 of immersive video according to an embodiment of the present invention may include a view optimizer 210, an Atlas constructor 220, a video texture information and depth information encoder 230, and a metadata composer 240. However, the encoder is not limited to these constitutional units and may include additional constitutional units not illustrated herein.

The view optimizer 210 may select at least one basic-view image and at least one additional view image from at least one source view image taken by a plurality of cameras. Here, each of the source view image, the basic-view image, and the additional view image may include a texture component and a depth component. In addition, the at least one source view image may mean an immersive video consisting of multi views. In addition, a texture component and a depth component may be used in the same meaning as texture information and depth information, respectively.

The atlas constructor 220 may include a pruner 221, an aggregator 222, and a patch packer 223. However, the atlas constructor 220 is not limited to these constitutional units and may include additional constitutional units not illustrated herein.

The atlas constructor 220 may remove an overlapping region between view images on the basis of at least one of the depth information of at least one basic-view image, the depth information of at least one additional view image, and a camera parameter.

Specifically, the atlas constructor 220 may perform a pruning process for extracting only image information with no overlapping region from an immersive video consisting of multiple views. Here, the pruning process may be performed in the pruner 221. The pruning process may be applied to a depth component of an image. Alternatively, the pruning process may be applied not only to a depth component but also to a texture component of an image.

A pruning process may mean a process of extracting an image region that is not included in a basic-view image and other additional view image but is seen only at a corresponding view position. As a result of the pruning process, a pruning mask image may be generated. A pruning mask image may have a function of displaying only a region to be extracted in an image at a corresponding view position. In addition, a pruning mask image may be binary video data that display a non-overlapping region through a comparison among a corresponding view image using a three-dimensional image signal, a basic-view image, and other additional view images.

A pruning mask may be defined as a region corresponding to effective texture data within a pruning mask image.

A patch may be generated based on texture data corresponding to a pruning mask. A patch may be defined as a square region including data that include data of a non-overlapping region. A patch packer 223 may generate a patch of each view position image by extracting a texture component (non-overlapping image region) corresponding to a pruning mask of each view position image from view position images and generate a packed view by packing patches of view position images into a small number of images. Herein, a packed view may be referred to as atlas.

A packed view may be an ultimate format that is input into a usual video codec (for example, AVC, HEVC, VVC, etc.). In other words, a basic-view image and a packed view may be transmitted to a usual video codec and be decoded.

For example, referring to FIG. 2 and FIG. 3, the atlas constructor 220 may perform pruning by using a basic-view image (Vₖ) and an additional view image (Vₖ₋₁) as inputs. Herein, in order to extract the regions of Object 1 (01) and Object 4 (04), which are non-overlapping regions, from a basic-view image and an additional view image, a first mask (Mask 1) and a second mask (Mask 2) may be generated as pruning masks. Herein, image regions corresponding to Mask 1 and Mask 2 may not be seen in a basic-view image but be seen only in a corresponding additional view image. Then, as a first patch (Patch 1) and a second patch (Patch 2) thus generated are packed, a packed view, that is, atlas may be generated. Information on a plurality of residual additional view images including an atlas thus generated and information on a basic-view image may be transmitted through a bitstream.

Meanwhile, when patches extracted from each view image are generated as a packed view, the patches are configured by at least one image frame. Accordingly, the packing efficiency in a patch packing process is to be improved to reduce the size and/or number of packed views, and the compression efficiency on a boundary of a patch that is configured in a square is to be improved.

According to an embodiment of the present invention, among methods for efficiently packing patches and reducing the amount of transmitted data, there is one method that scales patch sizes according to the importance of each patch and allocates patches in an empty space of a packed view by rotating the patches. Herein, the important thing is that, when an image is reconstructed in a decoder, the degradation of image quality due to the adjustment of patch size and rotation of patches is to be minimized. In the case of a single view image, depending on whether or not it is a region of interest (ROI), the adjustment of patch size may be worthy of consideration. However, in the case of immersive media where a plurality of view images and additional depth information are transmitted, a more adequate method of adjusting patch sizes is required.

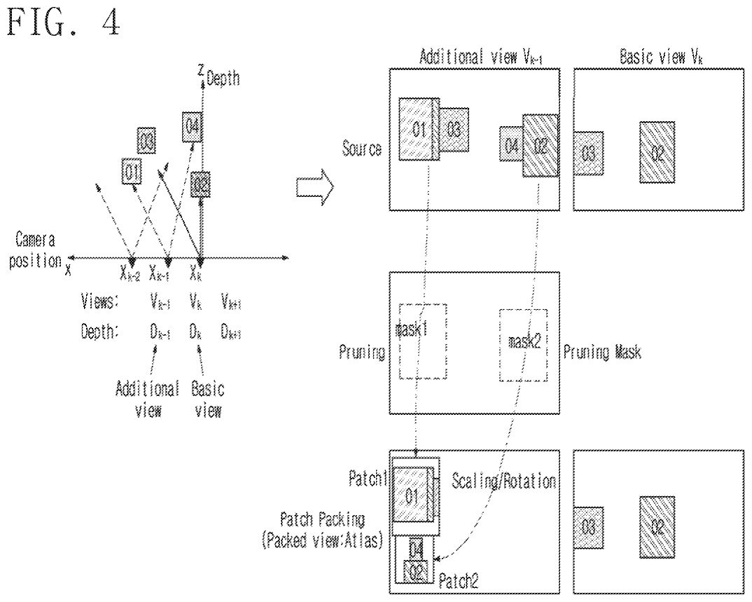

FIG. 4 is a view for explaining a method of adjusting a patch size by using the importance of an image region to be extracted into a patch, according to an embodiment of the present invention.

According to an embodiment of the present invention, when packing patches and generating a packed view, patch sizes may be differentially adjusted according to the importance of an image region to be extracted in each patch. Herein, a factor for determining the importance of an image region may include at least one of a depth value of the image region, the camera position used for obtaining the image region, whether or not the image region is a ROI, a priority order of images, and a pruning order.

In addition, when a packed view is generated, some patches may be packed by being rotated.

Consequentially, as the volume of data transmitted is reduced by scaling and rotation in each patch, the packing efficiency of a patch may be enhanced.

In case a factor for determining a patch size is a depth value, when a multi-view image is obtained, most of the focused regions and gazed regions from the viewpoint of a viewer may be determined based on a depth value. Accordingly, the depth value may determine the importance of an image region.

In case a factor for determining a patch size is a camera position, the importance may be set to be lower from the center to edges of multiple cameras. For example, when a camera index is sequentially allocated according to camera positions, since the difference of camera indexes increases at a further position from a center camera, the importance of image may be set to be lower as the difference of index from the center camera becomes larger. For another example, the importance of image may be set based on a predetermined interval of multiple cameras (for example, in every even or odd place). Here, the predetermined interval may be a predefined value or be adaptively determined according to the number of overall images.

In case a factor for determining a patch size is a priority order of images, a patch consisting of a video region with higher complexity may be set to have a higher importance than a patch consisting of a video region with lower complexity. This is because, when the complexity of an image region within a patch is high, the adjustment of size significantly degrades the quality of reconstructed image.

For example, referring to FIG. 4, a second patch (Patch 2) corresponding to a patch region of Object 2 (02) and Object 4 (04) may be packed by being scaled and rotated according to the importance of a corresponding image region determined by one of the above-described methods.

Information on importance of patches may be encoded as metadata. For example, a 1-bit flag indicating whether or not a patch is included in a ROI may be encoded. Alternatively, information on an importance order may be encoded.

According to patch importance, an adjustment ratio of patch size may be determined. For example, size adjustment ratios may be different between an important patch and a non-importance patch.

Alternatively, information indicating at least one of an adjustment ratio of patch size and rotation may be encoded as metadata. For example, information indicating at least one of an original patch size, a patch size after size adjustment, and a ratio between before and after size adjustment may be encoded and used to determine an adjustment ratio of patch size. For example, information indicating at least one of whether or not rotation is clockwise, whether or not rotation is anti-clockwise, and a rotation angle may be encoded and used to determine whether or not a patch is rotated.

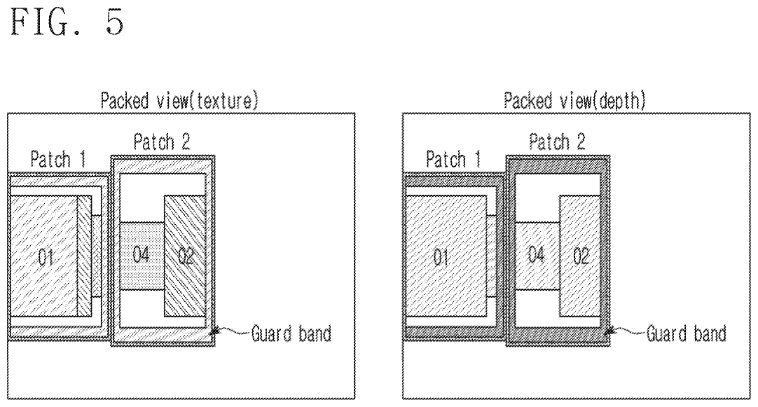

FIG. 5 is a view for explaining a method of improving an encoding efficiency by adjusting the width of a guard band, according to an embodiment of the present invention.

A packed view generated by a patch packing process may be compressed through the texture component and depth component encoder 230 illustrated in FIG. 2. Herein, since a boundary portion between patches is a high-frequency component, and an image region between boundaries has a low correlation, the compression efficiency may be decreased.

Accordingly, according to an embodiment of the present invention, as illustrated in FIG. 5, a guard band may be set in a boundary region of patch. Set in a boundary region of patch, a guard band may mean a region that separates a boundary of patch to prevent the degradation of compression efficiency in the boundary. Encoding efficiency may be improved through filtering and filling suitable for a guard band region. Here, a guard band may be set both for a texture component and for a depth component.

For example, a pixel value included in a guard band may be generated by copying a sample adjacent to a boundary region of a patch.

For another example, a pixel value included in a guard band may be generated by interpolating a plurality of samples included in a boundary region of a patch.

As illustrated in the right side of FIG. 5, in order to indicate whether or not a text image pixel is included in a guard band, a specific level of depth information values may be allocated to the guard band. For example, among 1024 levels of depth information values, the lowest 32 levels may indicate a guard band.

Here, like in the above description regarding FIG. 4, the width of the guard band may be determined based on the importance of an image region. Herein, the importance of an image region may be determined based on at least one of a depth value of the image region, a camera position used for obtaining the image region, whether or not the image region is a ROI, a priority order of images, and a pruning order. In addition, the size of a guard band may be determined based on the size of a patch. In addition, the width of a guard band in each patch may be determined based on a priority order of patches.

According to an exemplary embodiment, the width of a guard band may be additionally transmitted through metadata that define a patch. Alternatively, information showing the size of a horizontal guard band and that of a vertical guard band may be separately encoded.

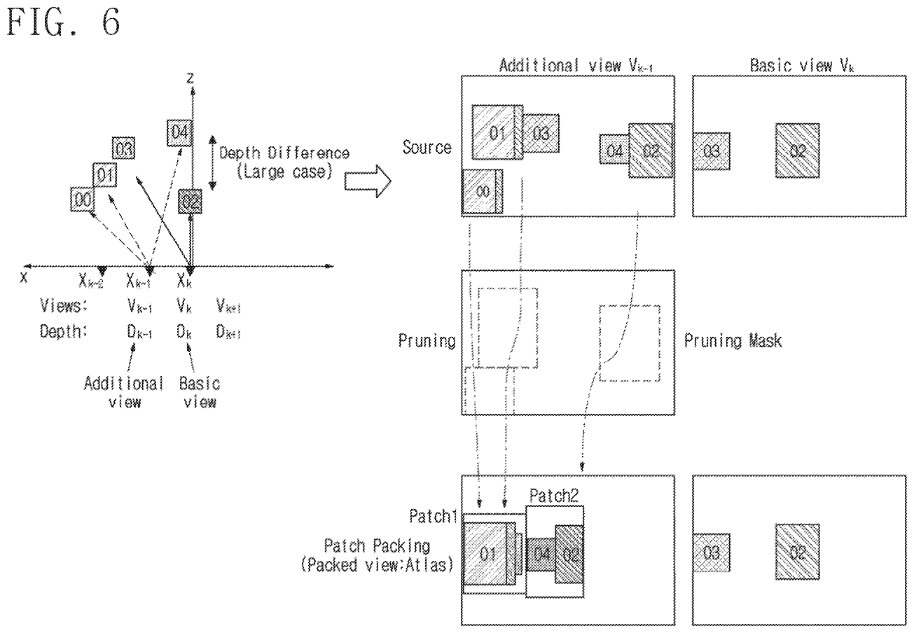

FIG. 6 is a view for explaining a method of packing similar multiple patch regions into a single patch, according to an embodiment of the present invention.

When extracting a patch from an additional view image using a pruning mask, there may be similar image regions. Thus, according to an embodiment of the present invention, an amount of data may be reduced by detecting a similarity between extracted images and packing similar multiple patch regions into a single patch.

For example, when extracted image regions include similar pixel values, the image regions may be determined as similar image regions. Accordingly, image regions including similar pixel values may be packed into a single patch.

Herein, when a similarity is increased by applying an adequate transform (for example, Similarity transform, Affine transform) between extracted image regions, such an adequate transform may be adopted to pack the image regions into a single patch. Meanwhile, an encoder may additionally transmit a transform parameter related to the transform, and a decoder may receive the parameter, perform an inverse transform and reconstruct the patch.

For example, referring to FIG. 6, image regions including the object 0 (00) and the object 1 (01), which exist in the additional view image Vₖ₋₁, may be determined as similar image regions. Accordingly, the patch regions corresponding to 00 and 01 may be packed into a single patch, that is, a first patch (Patch 1), thereby reducing an amount of data.

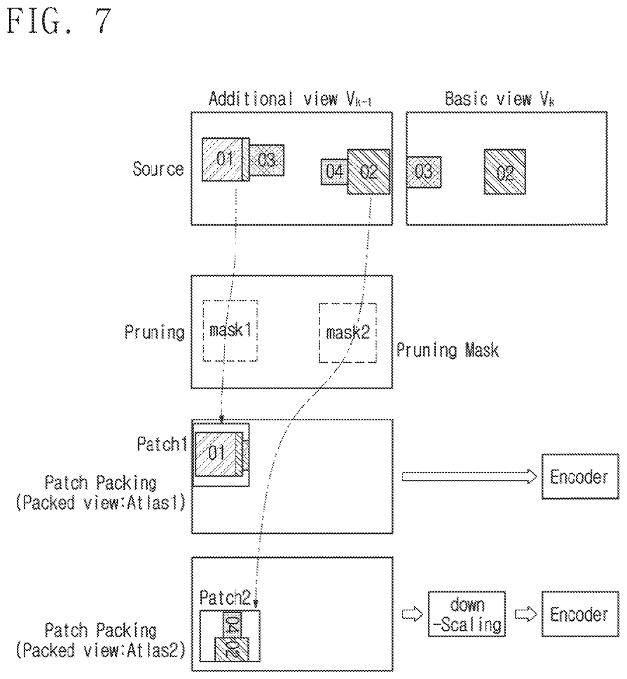

FIG. 7 is a view for explaining a patch packing method for each atlas according to an embodiment of the present invention.

According to an exemplary embodiment, when a patch is packed into an atlas (or a packed view), patches may be separated into different atlases (for example, Atlas 1 and Atlas 2) according to the importance of an image region that is to be extracted into a patch. Herein, a factor for determining the importance of an image region may include at least one of a depth value of the image region, the camera position used for obtaining the image region, whether or not the image region is a ROI, a priority order of images, and a pruning order.

Referring to FIG. 7, after patches are separated into different atlases (for example, Atlas 1 and Atlas 2), an atlas packed with patches having low importance (for example, Atlas 2) may be down-scaled again to be compressed and transmitted. According the exemplary embodiment, as the size of an atlas generated in a usual image format is adjusted in a server and a terminal respectively, the advantage of simple implementation may be obtained.

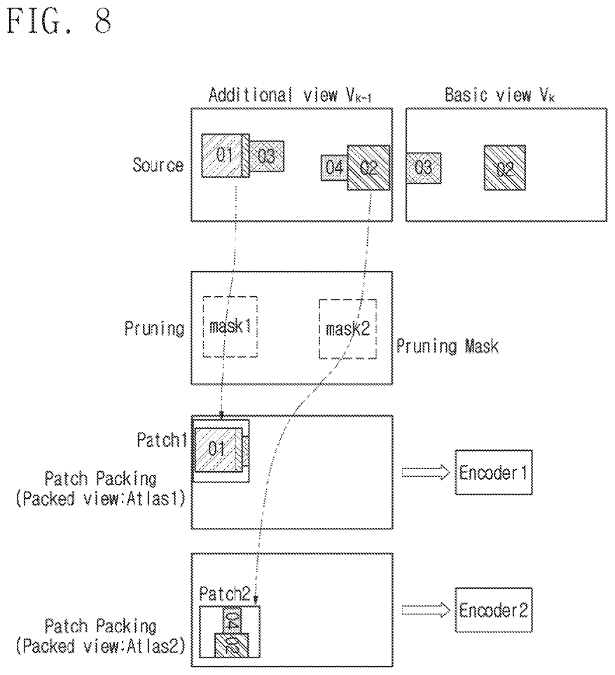

FIG. 8 is a view for explaining a method of performing video encoding differently for each atlas, according to an embodiment of the present invention.

According to an exemplary embodiment, when a patch is packed into an atlas (or a packed view), patches may be separated into different atlases (for example, Atlas 1 and Atlas 2) according to the importance of an image region that is to be extracted into a patch. Herein, a factor for determining the importance of an image region may include at least one of a depth value of the image region, the camera position used for obtaining the image region, whether or not the image region is a ROI, a priority order of images, and a pruning order.

Referring to FIG. 8, after patches are separated into different atlases (for example, Atlas 1 and Atlas 2), an atlas packed with patches having high importance may be compressed at a low compression rate in a first encoder (Encoder 1), and an atlas packed with patches having low importance may be compressed at a high compression rate in a second encoder (Encoder 2). Thus, according to the exemplary embodiment, different decoding qualities may be rendered, while an overall same video compression rate is maintained.

In addition, according to the exemplary embodiment, in a service environment with a limited transmission rate, a video region with high importance may be viewed in high definition, while, on the contrary, a video region with low importance may be viewed in relatively low definition. Thus, a viewer' s overall satisfaction may be improved.

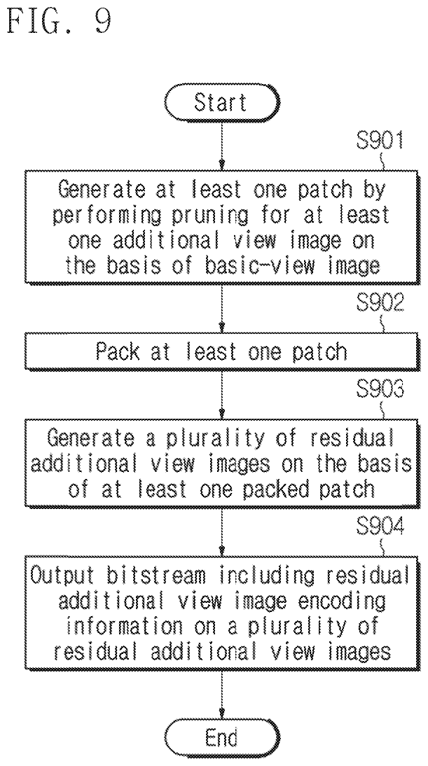

FIG. 9 is a view for explaining a method of encoding a multi-view image according to an embodiment of the present invention.

Referring to FIG. 9, a multi-view image encoder may generate at least one patch by performing pruning for at least one additional view image on the basis of a basic-view image (S901).

In addition, the multi-view image encoder may pack at least one patch (S902). Here, the step S902 may be performed based on the importance of an image region that belongs to an additional view image.

Meanwhile, the importance of an image region that belongs to an additional view image may be determined on the basis of at least one of a depth value of the image region belonging to the additional view image, the position of a camera used to obtain the image region, whether or not the image region is a region of interest, and the complexity of the image region.

Meanwhile, the packing of at least one patch (S902) may include adjusting the size of a patch according to the importance of an image region that belongs to an additional view image.

In addition, the packing of at least one patch (S902) may include rotating a patch according to the importance of an image region that belongs to an additional view image.

In addition, the packing of at least one patch (S902) may include setting a guard band in the boundary portion of at least one patch.

Meanwhile, the setting of a guard band may set the guard band according to the importance of an image region that belongs to an additional view image.

In addition, the setting of a guard band may set the guard band by copying sample values adjacent to the boundary portion of at least one patch.

In addition, the setting of a guard band may set the guard band by interpolating a plurality of samples included in the boundary portion of at least one patch.

Meanwhile, the packing of at least one patch (S902) may include determining the similarity of a plurality of image regions that belong to an additional view image and packing at least one patch into a single patch on the basis of a result of similarity determination.

In addition, a multi-view image encoder may generate a plurality of residual additional view images on the basis of at least one packed patch (S903).

In addition, a multi-view image encoder may output a bitstream including residual additional view image encoding information on a plurality of residual additional view images (S904). Here, the bitstream may further include basic-view image encoding information on a basic-view image.

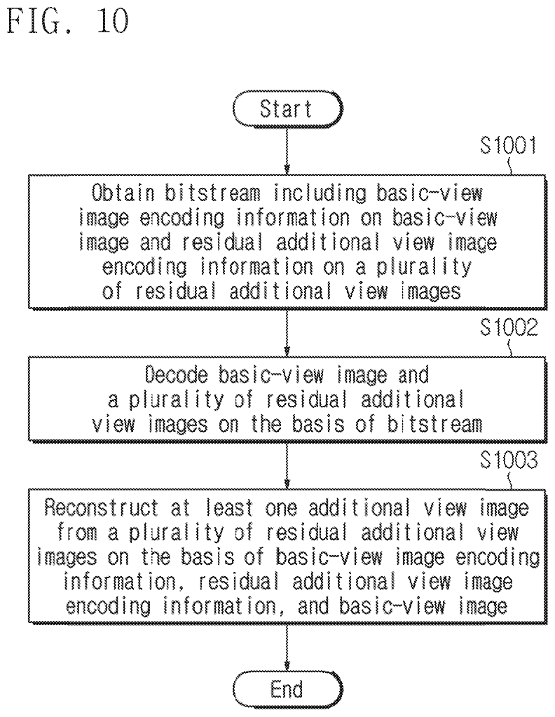

FIG. 10 is a view for explaining a method of decoding a multi-view image according to an embodiment of the present invention.

Referring to FIG. 10, a multi-view image decoder may obtain a bitstream including basic-view image encoding information on a basic-view image and residual additional view image encoding information on a plurality of residual additional view images (S1001). Here, the residual additional view image encoding information may include the packing information of a patch.

In addition, the packing information may include information on the importance of an image region that belongs to an additional view image. In addition, the packing information may include information on a guard band of a patch.

In addition, the packing information may include information on the similarity of a plurality of image regions that belong to an additional view image.

Meanwhile, a guard band may be determined based on the importance of an image region belonging to an additional view image.

Meanwhile, the importance of an image region that belongs to an additional view image may be determined on the basis of at least one of a depth value of the image region belonging to the additional view image, the position of a camera used to obtain the image region, whether or not the image region is a region of interest, and the complexity of the image region.

In addition, the size of the patch may be determined based on the importance of an image region belonging to an additional view image.

In addition, a multi-view image decoder may decode a basic-view image and a plurality of residual additional view images on the basis of a bitstream (S1002).

In addition, a multi-view image decoder may reconstruct at least one additional view image from a plurality of residual additional view images on the basis of basic-view image encoding information, residual additional view image encoding information, and a basic-view image (S1003).

A bitstream generated by the image encoding method of the present invention may be temporarily stored in a non-transitory computer-readable recording medium and may be encoded by the above-mentioned multi-view image encoding method.

Specifically, in a non-transitory computer-readable recording medium storing a bitstream related to a method of encoding a multi-view image including a basic-view image and at least one additional view image, the method of encoding the multi-view image may include generating at least one patch by performing pruning for the at least one additional view image on the basis of the basic-view image, packing the at least one patch, based on the at least one patch thus packed, generating a plurality of residual additional view images, and outputting a bitstream including residual additional view image encoding information on the plurality of residual additional view images. The packing of the at least one patch may be performed based on the importance of an image region belonging to the additional view image.

Although the exemplary methods of the present invention are represented by a series of acts for clarity of explanation, they are not intended to limit the order in which the steps are performed, and if necessary, each step may be performed simultaneously or in a different order. In order to implement a method according to the present invention, the illustrative steps may include an additional step or exclude some steps while including the remaining steps. Alternatively, some steps may be excluded while additional steps are included.

The various embodiments of the present invention are not intended to be all-inclusive and are intended to illustrate representative aspects of the disclosure, and the features described in the various embodiments may be applied independently or in a combination of two or more.

In addition, the various embodiments of the present invention may be implemented by hardware, firmware, software, or a combination thereof. In the case of hardware implementation, one or more application specific integrated circuits (ASICs), digital signal processors (DSPs), digital signal processing devices (DSPDs), programmable logic devices (PLDs), field programmable gate arrays (FPGAs), a general processor, a controller, a microcontroller, and a microprocessor may be used.

The scope of the present invention includes software or machine-executable instructions (for example, an operating system, applications, firmware, programs, etc.) that enable operations according to the methods of various embodiments to be performed on a device or computer, and a non-transitory computer-readable medium in which such software or instructions are stored and are executable on a device or computer.

What is claimed is:

1. A multi-view image encoding method for a multi-view image comprising a basic-view image and at least one additional view image, the multi-view image encoding method comprising:
generating at least one patch by performing pruning for the at least one additional view image on the basis of the basic-view image;
packing the at least one patch;
generating a plurality of residual additional view images on the basis of the at least one packed patch; and
outputting a bitstream comprising residual additional view image encoding information on the plurality of residual additional view images,
wherein the packing of the at least one patch is performed based on an importance of an image region belonging to the additional view image.

2. The multi-view image encoding method of claim 1,
wherein the packing of the at least one patch comprises adjusting a size of the patch according to the importance of the image region belonging to the additional view image.

3. The multi-view image encoding method of claim 1,
wherein the packing of the at least one patch comprises rotating the patch according to the importance of the image region belonging to the additional view image.

4. The multi-view image encoding method of claim 1,
wherein the importance of the image region belonging to the additional view image is determined on the basis of at least one of a depth value of the image region, a position of a camera used to obtain the image region, whether or not the image region is a region of interest, and a complexity of the region.

5. The multi-view image encoding method of claim 1,
wherein the packing of the at least one patch comprises setting a guard band in a boundary portion of the at least one patch.

6. The multi-view image encoding method of claim 5,
wherein the setting of the guard band comprises setting the guard band according to the importance of the image region belonging to the additional view image.

7. The multi-view image encoding method of claim 5,
wherein the setting of the guard band comprises copying a sample value adjacent to the boundary region of the at least one patch.

8. The multi-view image encoding method of claim 5,
wherein the setting of the guard band comprises setting the guard band by interpolating a plurality of samples comprised in the boundary region of the at least one patch.

9. The multi-view image encoding method of claim 1,
wherein the packing of the at least one patch comprises:
determining a similarity of a plurality of image regions belonging to the additional view image; and
packing the at least one patch into a single patch on the basis of a result of the similarity determination.

10. The multi-view image encoding method of claim 1,
wherein the bitstream further comprises basic-view image encoding information on the basic-view image.

11. A multi-view image decoding method for a multi-view image comprising a basic-view image and at least one additional view image, the multi-view image decoding method comprising:
obtaining a bitstream comprising basic-view image encoding information on the basic-view image and residual additional view image encoding information on a plurality of residual additional view images;
decoding the basic-view image and the plurality of residual additional view images based on the bitstream; and
reconstructing the at least one additional view image from the plurality of residual additional view images based on the basic-view image encoding information, the residual additional view image encoding information and the basic-view image,
wherein the residual additional view image encoding information comprises packing information of a patch, and
wherein the packing information comprises information on an importance of the image region belonging to the additional view image.

12. The multi-view image decoding method of claim 11,
wherein a size of the patch is determined based on the importance of the image region belonging to the additional view image.

13. The multi-view image decoding method of claim 11,
wherein the importance of the image region belonging to the additional view image is determined on the basis of at least one of a depth value of the image region, a position of a camera used to obtain the image region, whether or not the image region is a region of interest, and a complexity of the region.

14. The multi-view image decoding method of claim 11,
wherein the packing information comprises information on a guard band of the patch.

15. The multi-view image decoding method of claim 14,
wherein the guard band is determined based on the importance of the image region belonging to the additional view image.

16. The multi-view image decoding method of claim 11,
wherein the packing information comprises information on a similarity of a plurality of image regions belonging to the additional view image.

17. A non-transitory computer-readable recording medium for storing a bitstream generated by a multi-view image encoding method for a multi-view image comprising a basic-view image and at least one additional view image,
wherein the multi-view image encoding method comprises:
generating at least one patch by performing pruning for the at least one additional view image on the basis of the basic-view image;
packing the at least one patch;
generating a plurality of residual additional view images based on the at least one packed patch; and
outputting a bitstream comprising residual additional view image encoding information on the plurality of residual additional view images,
wherein the packing of the at least one patch is performed based on the importance of the image region belonging to the additional view image.
